(19) United States
(12) Patent Application Publication
(10) Pub. No.: US 2007/0276753 A1
(43) Pub. Date: Nov. 29, 2007

(54) System and Method for Selling a Disposable Giftcard at a Store Location of a First Retailer for Exclusive use at a Second Retailer

(75) Inventors: Michael Bleser, Deerfield, IL (US); Allan M. Resnick, Northbrook, IL (US); Laura Merten, Deerfield, IL (US); John William Gleeson II, Chicago, IL (US)

Correspondence Address: FRANCIS C. KOWALIK;WALGREEN CO. LAW DEPARTMENT, 104 WILMOT ROAD, M.S. #1425, DEERFIELD, IL, 60015, US

(73) Assignee: WALGREEN CO., Deerfield, IL (US)

(21) Appl. No.: 11/778,911

(22) Filed: Aug. 15, 2007

Related U.S. Application Data
(63) Continuation of application No. 09/852,501, filed on May 10, 2001.
(60) Provisional application No. 60/203,490, filed on May 10, 2000.
(60) Provisional application No. 60/203,834, filed on May 12, 2000.

(51) Int. Cl. G06Q 40/00

(52) U.S. Cl. 705/39

(57) ABSTRACT

A method for selling a disposable giftcard at a store location of a first retailer for exclusive use at a second retailer is disclosed. The method includes: the first retailer displaying in a store location of the first retailer a plurality of non-activated giftcards of the second retailer that may be exclusively used at the second retailer; the first retailer activating one of the displayed giftcards of the second retailer for exclusive use at the second retailer, following: receiving from a customer of the first retailer a selection of one of the displayed giftcards of the second retailer at the store location of the first retailer; and the first retailer receiving from the customer of the first retailer a payment amount for the selected one of the giftcards of the second retailer. The first retailer transferring a revenue share to the second retailer in accordance with the giftcard information.

### CROSS-REFERENCE TO RELATED APPLICATION

This application is a continuation of U.S. application Ser. No. 09/852,501, filed May 10, 2001, which claims the benefit of U.S. provisional patent application Ser. No. 60/203,490 filed May 10, 2000, and U.S. provisional patent application Ser. No. 60/203,834, the disclosures of which are incorporated herein by reference.

### FIELD OF THE INVENTION

The invention generally relates to methods of transacting retail sales and, more particularly, to methods of selling gift certificate cards.

### BACKGROUND OF THE INVENTION

Gift certificate cards, or giftcards, have recently gained in popularity as an alternative to traditional paper gift certificates. Giftcards are typically provided in a form similar to that of credit cards. Accordingly, a typical giftcard includes a rectangular plastic body having a strip for magnetically storing information. The giftcard is redeemable for merchandise or services provided by the retailer that issued the giftcard.

Giftcards are typically in an inactive state until purchased. When the giftcard is purchased, it is typically swiped through a card reader which reads the information stored on the giftcard and forwards the information to the retailer's computer center. The computer center, in turn, forwards information to a giftcard processor, which may be provided by the retailer or, more typically, an outside party, thereby activating the giftcard. The giftcard may then be used at a store of the retailer.

Giftcards of a particular retailer are typically sold only inside a store location of that retailer. As a result, a customer desiring to purchase a giftcard of an outside retailer must go to a store location of that retailer, thereby inconveniencing the customer. In addition, customers may want to purchase giftcards usable at several locations. Currently, the customer must travel to a store location of each retailer to purchase a giftcard usable at that location.

Gift certificate kiosks are known for generating gift certificates for one or more remote or off-site retailers. Veeneman et al., U.S. Pat. No. 5,243,174, for example, discloses a method and apparatus for generating gift certificates in which a dispensing device, such as a kiosk, is provided. The consumer inserts a credit card into the device and uses a touchscreen to select a retailer from a menu of participating retailers and enters a value for the gift certificate. The dispensing device verifies the credit card, debits the appropriate account, and prints a gift certificate.

The dispensing device of Veeneman et al. is overly difficult and cumbersome to use. The consumer must be comfortable with using touchscreens, and must respond to a series of queries in order to select a retailer and the desired amount for the gift certificate. Furthermore, marketing of the gift certificates is limited to the appearance of the kiosk and artwork or graphics shown thereon, and the gift certificate is not viewable until purchased and dispensed.

### SUMMARY OF THE INVENTION

In accordance with certain aspects of the invention, a method is provided for selling a giftcard at a store location of a first retailer for use at a second retailer. The method comprises displaying giftcards in the store location of the first retailer, activating a giftcard upon receipt of a purchase amount from a customer, and forwarding active giftcard information to a processor associated with the second retailer. Proceeds are transferred from the first retailer to the second retailer, the proceeds including at least a portion of the purchase amount.

In accordance with additional aspects of the invention, a method is provided for selling a giftcard at a store location of a first retailer for use at a plurality of second retailers. The method comprises displaying giftcards in the store location of the first retailer, activating a giftcard upon receipt of a purchase amount from a customer, and forwarding active giftcard information to a processor associated with the plurality of second retailers. Proceeds are transferred from the first retailer to the plurality of second retailers, the proceeds including at least a portion of the purchase amount.

Other features and advantages are inherent in the disclosed apparatus or will become apparent to those of ordinary skill in the art from the following detailed description and its accompanying drawings.

### BRIEF DESCRIPTION OF THE DRAWINGS

FIG. 1 is a flow chart of the steps followed during a gift card sale, in accordance with the teachings of the present invention.

### DETAILED DESCRIPTION OF THE PREFERRED EMBODIMENT

One method according to the present invention generally relates to the sale of a giftcard at a store location of a first retailer, which is usable at a second or outside retailer. As used herein, the term “giftcard” is intended to include all types of portable storage devices, such as cards, certificates and other documents capable of storing or denoting a credit value. This definition includes conventional credit card style giftcards, on which information may be stored, phone cards, and smart cards, which may store, process, and update information, among other storage media.

In the currently preferred embodiment, the giftcard is provided in a form similar to that of a conventional credit card. Accordingly, the giftcard has a generally rectangular, plastic substrate with a magnetic strip for storing information. It will be appreciated that the precise shape of and materials used for the giftcard is not critical and, in fact, any type of portable storage device may be used. For example, the giftcard may be in the form of a key chain card having storage means affixed thereto.

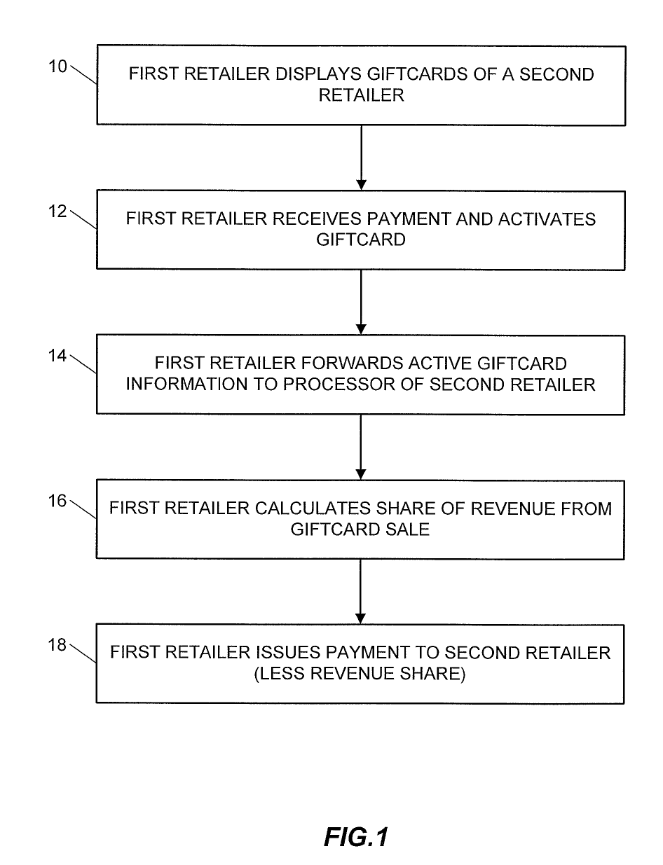

The steps for performing a giftcard sale in accordance with the teachings of the invention are shown in flowchart form at FIG. 1. Accordingly, as indicated with reference numeral 10, a first retailer displays giftcards of a second retailer. The giftcards may be enclosed in packaging to attract the attention of customers. Furthermore, the giftcards may be placed in a display fixture that may incorporate additional marketing artwork, such as signage. The giftcards are preferably positioned in a high traffic area of the store, such as near a front register.

A customer selects a giftcard and brings it to a register for purchase. The customer may use any payment means accepted by the first retailer to purchase the card. Once payment is received, the first retailer activates the giftcard 12. The register includes a card reader through which the giftcard may be swiped. Encoded on the giftcard is a card identification number. The register forwards the card identification number for the giftcard to a first retailer computer center, which updates the giftcard to active status. The computer center of the first retailer then forwards the active giftcard information to a processor of the second retailer 14. The processor may be provided by the second retailer in-house, or may be a third party card processor.

In addition to activating the giftcard, the computer center of the first retailer may also calculate a share of revenue 16 from the giftcard sale as consideration for marketing and selling the giftcard. The first retailer's share may be a fixed fee or may be a percentage of the dollar value of the giftcard.

Finally, the first retailer issues payment to the second retailer as a result of the giftcard sale 18. Payment may be issued upon each giftcard sale or periodically (such as monthly) to reflect multiple giftcard sales. Furthermore, the first retailer's revenue share may be subtracted from the amount of the payment made to the second retailer. In addition to the payment, the first retailer may provide detailed reports to the second retailer indicating the number of giftcards sold at specific value amounts, the total number of giftcards sold, and other sales information.

In the preferred embodiment, the giftcard may have a credit value, such as $10, $15, and $25. The credit value may be prominently displayed on the giftcard and associated packaging. The card processor may pre-assign credit values according to card identification number, so that during giftcard activation, the appropriate credit value is reflected at the card processor. As a result, a customer may simply select a giftcard having a desired credit value and proceed to the register. During activation, the giftcard is swiped through the card reader and a credit value corresponding to the desired amount is automatically activated.

In the alternative, the credit value may be assigned as the giftcard is being purchased. In this alternative, rather than pre-assigning a credit value to an inactive card, the credit value is entered at the register before or after the giftcard is swiped through the card reader 16. The first retailer employee may enter any desired value to the giftcard, and the manually-entered credit value is forwarded to the processor during activation.

In an additional embodiment, the giftcard is provided in the form of a smart card. Unlike the magnetic storage strips used in the credit card style giftcards, the smart card giftcards are embedded with a microprocessor and memory. As a result, information such as credit values may be stored and adjusted directly on the card. In the smart card embodiment, a smart card reader is used to store the desired credit value on the card when it is purchased.

It will further be appreciated that while the above embodiment discloses cards usable at a single second retailer, the method may be used to sell giftcards of multiple second (or outside) retailers. In this embodiment, a set of giftcards is displayed for each outside retailer. The first retailer computer center may be programmed so that the card identification number directs the information to the appropriate processor, if more than one processor is used by the various outside retailers.

In accordance with additional aspects of the present invention, the first retailer may sell a single, multi-store giftcard that may be used at a variety of outside retailers. In this embodiment, a consortium of outside retailers may be formed that will accept the multi-store giftcard as payment for merchandise. Similar to the previous embodiments, the first retailer displays the multi-store giftcards at one of its store locations. Any display fixtures and marketing artwork, as well as the giftcards themselves, may be clearly marked to indicate the participating outside retailers at which the giftcard may be used. The first retailer receives payment for and activates the giftcard, forwarding active card information to a processor used by the multiple retailer consortium. The first retailer may then calculate a revenue share from the sale of the giftcard, and issue payment to the multiple retailer consortium.

From the foregoing, it will be appreciated that a new and improved method of selling giftcards is provided. While displayed for sale in a first retailer, the giftcards may be redeemed at a second retailer. As a result, the customer need not travel to a store location of the second retailer to purchase the giftcard. This is particularly advantageous when the second retailer is a local or regional retailer that may not have store locations near the customer.

Although certain apparatus constructed in accordance with the teachings of the invention have been described herein, the scope of coverage of this patent is not limited thereto. On the contrary, this patent covers all embodiments of the teachings of the invention clearly falling within the scope of the appended claims either literally or under the doctrine of equivalents.

What is claimed is:

1. A method for selling a disposable giftcard at a store location of a first retailer for exclusive use at a second retailer, the method comprising:
the first retailer displaying in a store location of the first retailer a plurality of non-activated giftcards of the second retailer that may be exclusively used at the second retailer;
the first retailer activating one of the displayed giftcards of the second retailer for exclusive use at the second retailer, following:
i) receiving from a customer of the first retailer a selection of one of the displayed giftcards of the second retailer at the store location of the first retailer; and
ii) the first retailer receiving from the customer of the first retailer a payment amount for the selected one of the giftcards of the second retailer; and
the first retailer transferring a revenue share to the second retailer in accordance with the giftcard information including at least a portion of the payment amount,
wherein activating one of the displayed giftcards includes updating giftcard information of the giftcard to active status and forwarding active giftcard information to a processor of the second retailer for the second retailer.

2. The method of claim 1, wherein activating one of the displayed giftcards of the second retailer for exclusive use at the second retailer comprises restricting the use of the one of the displayed giftcards to only the second retailer.

3. The method of claim 1, wherein the giftcard contains signage indicating that the giftcard is of the second retailer.

4. The method of claim 3, wherein the signage is a logo of the second retailer.

5. The method of claim 1, wherein the first retailer provides the processor of the second retailer giftcard identification information and a credit value of each giftcard, wherein the giftcard identification information identifies giftcards for exclusive use at the second store.

6. A system for selling a disposable giftcard at a store location of a first retailer for exclusive use at a second retailer comprising:
a first giftcard for exclusive use at a second retailer, wherein the first giftcard contains a first identification number;
a register located at the store location of a first retailer, wherein the register is adapted to read the first identification number from the first giftcard and forward the first identification number to a first retailer computer center for activation; and
a first retailer computer center that is adapted to activate the first giftcard for exclusive use at the second retailer by updating giftcard information associated with the first identification number to active status and forwarding the active giftcard information including the giftcard identification number to a processor of the second retailer.

7. The system of claim 6, wherein the first retailer computer center is adapted to only send the active giftcard information including the first identification number to the processor of the second retailer.

8. The system of claim 7, wherein the first retailer computer is adapted to enable the first giftcard to be uniquely identifiable at the second retailer by forwarding the first identification number from the first retailer computer center to only the processor of the second retailer for the second retailer.

9. The system of claim 6, wherein a credit value of the second retailer for the first giftcard is pre-assigned to the giftcard identifier.

10. The system of claim 9, wherein the first retailer computer center is adapted to activate the first giftcard of the second retailer to reflect the credit value of the second retailer by forwarding the active status of the first identification number to the processor of the second retailer.

11. The system of claim 6, further comprising a second giftcard for exclusive use at a third retailer, wherein the giftcard contains a second identification number and wherein the first retailer computer center is adapted to activate the second giftcard for exclusive use at the third retailer by updating giftcard information associated with the second identification number to active status and forwarding the active giftcard information including the second identification number to a processor of the third retailer.

12. The system of claim 11, wherein the first retailer computer center is adapted to only send the active giftcard information of the second giftcard including the second giftcard identifier to the processor of the third retailer.

13. The system of claim 11, wherein the first retailer computer center is adapted to only send the active giftcard information of one of the first or second giftcards to a processor of the second or third retailer to which the giftcard belongs.

14. The system of claim 6, wherein the register is adapted to receive a manually-entered credit value associated with the first identification number and forward the value to the processor of the second retailer during activation.

15. The system of claim 14, wherein the giftcard is a smart card and wherein the manually-entered credit value of the giftcard is stored on a processor or memory of the smartcard.

16. A method for selling a plurality of disposable giftcards at a store location of a first retailer, each giftcard of the plurality of giftcards for exclusive use at only one of a second retailer or a third retailer, the method comprising:
the first retailer displaying in a store location of the first retailer a first non-activated giftcard of the second retailer that may be exclusively used at the second retailer;
the first retailer displaying in the store location of the first retailer a second non-activated giftcard of the third retailer that may be exclusively used at the third retailer;
the first retailer activating at least one of the first giftcard for exclusive use with the second retailer or the second gift card for exclusive use with the third retailer, following:
i) receiving from a customer of the first retailer a selection of one of the displayed giftcards at the store location of the first retailer; and
ii) the first retailer receiving from the customer of the first retailer a payment amount for the selected one of the giftcards;
the first retailer forwarding active giftcard information pertaining to the selected one of the giftcards to either a processor of the second retailer if the selected card is the first card of second retailer, or a processor of the third retailer if the selected card is the second card of the third retailer; and
the first retailer transferring a revenue share including at least a portion of the payment amount to the second retailer, if the selected card is the first card of second retailer, or to the third retailer, if the selected card is the second card of the third retailer.

17. The method of claim 16, wherein the first giftcard of the second retailer displays signage indicating that the giftcard is of the second retailer and wherein the second giftcard of the third retailer displays signage indicating that the giftcard is of the third retailer.

18. The method of claim 16, wherein the processor of the second retailer stores a record of giftcard identifiers of giftcards for exclusive use with the second retailer and wherein the processor of the third retailer stores a record of giftcard identifiers of giftcards for exclusive use with the third retailer.

19. The method of claim 16, wherein the active giftcard information includes an active status and a giftcard identification number.

20. The method of claim 19, wherein the giftcard identification number is pre-assigned to a credit value of only one of the second retailer or third retailer.
